(19) United States
(12) Patent Application Publication
(10) Pub. No.: US 2026/0227566 A1
(43) Pub. Date: Aug. 6, 2026

(54) HOLLOW CORE OPTICAL FIBRE WITH YIELD TOLERANT MICROSTRUCTURE

(71) Applicant: University of Southampton, Redmond, WA (US)

(72) Inventor: Teofil Jasion GREGORY, Redmond, WA (US)

(73) Assignee: University of Southampton, Redmond, WA (US)

(21) Appl. No.: 19/152,375

(22) PCT Filed: Jan. 5, 2024
(86) PCT No.: PCT/US2024/010385

§ 371 Date: Jul. 30, 2025

(30) Foreign Application Priority Data
Jan. 19, 2023 (GB) 2300823.8

(51) Int. Cl. G02B 6/02; C03B 37/012; C03B 37/027

(52) U.S. Cl. CPC G02B 6/02328; C03B 37/0122; C03B 37/02781; C03B 2203/16

(57) ABSTRACT

A hollow core optical fibre (HCF) configured for guidance of an optical wave by antiresonance comprises a tubular glass jacket; a hollow core defined in the central lumen of the jacket and having in transverse cross-section a polygonal shape; and a cladding located in the central lumen and comprising flat planar glass membranes each having two opposite edges extending along a length of the HCF, membrane thickness<jacket wall thickness, the membranes arranged as a plurality of groups each comprising: a core boundary membrane defining one side of the polygonal shape; and at least one cladding membrane located between the core boundary membrane and the jacket, all membranes in the group being spaced apart; wherein every side of the polygonal shape is formed by a core boundary membrane, every membrane is anchored to the jacket only along its two opposite edges, and there is no contact between any membranes.

### BACKGROUND OF THE INVENTION

The present invention relates to hollow core optical fibres having a microstructure design which is conducive to high yield fabrication, and methods of fabrication.

Research in fibre optics has led to the development of “holey” optical fibres that include air- (or other gas-) filled longitudinal voids, lumens or capillaries within the internal structure of an individual fibre. Such fibres include hollow core optical fibres in which a central longitudinal void that acts as the waveguiding core is surrounded by a microstructured cladding formed from a specified arrangement of longitudinal voids, contained within an outer tubular jacket. Parameters of the voids including number, size, shape, relative position, and thickness of dividing membranes or walls are critical for ensuring good waveguiding performance of the optical fibres. The membranes are typically curved. As with conventional solid core optical fibres, hollow core optical fibres are fabricated using a fibre drawing process in which an initial preform or cane formed from glass and having a cross-sectional geometrical structure appropriate for forming an intended optical fibre with a defined structure, and on a much larger scale, is heated to soften the glass and then pulled or drawn in order to create a long length of optical fibre in which the required cross-sectional structure is developed from that of the preform. In order to achieve the desired microstructures at the end of the draw process, it is necessary to apply an increased internal pressure to the voids of the preform to prevent void collapse as the glass softens. Attainment of the required parameters to achieve the intended microstructure design requires the application of different pressures to different voids in order to counteract surface tension effects that would otherwise act to collapse or distort the various voids. In particular, differential pressures tend to be required to produce curved membranes in the microstructure from tubular elements commonly used in preforms, Selection of the appropriate pressures is a complex procedure, since an interplay exists between the surface tension and the applied pressures under which it is necessary to allow some parts of the fibre geometry to overshoot their intended dimensions early in the draw before contracting towards the target structure at the end of the draw. Increasing the yield of a draw, in other words the length of fibre it is possible to successfully fabricate as a continuous length or span, makes provision of the correct pressures more difficult. At long lengths, the contraction phase of the dynamic eventually becomes so aggressive that the initial overshoot required to pre-empt and counteract it is so large that unacceptable geometric deformations arise, such as contact between structural elements which are required to be spaced apart, or gross asymmetries of symmetrical elements. This difficulty puts upper limits on the lengths of hollow core optical fibre that can be successfully fabricated while maintaining quality. At the present time, the longest single span of hollow core having an acceptable level of optical propagation loss (about 5 dB/km) of which the inventors are aware has a 11 km length [1]. A length of approximately 13 km has also been demonstrated, with unspecified loss [2].

This limited length is a significant drawback. Hollow core optical fibres have superior optical propagation characteristics compared with solid core fibres, including reduced and flat chromatic dispersion, increased propagation speed, larger optical bandwidth, and reduced parasitic nonlinear optical effects, which arise from the large fraction of air inside the fibre and the corresponding reduced amount of glass, with light propagating mainly in the air and avoiding detrimental effects arising from propagation in glass, while recently attenuation has been dramatically reduced to levels comparable to that of solid fibres. These properties make hollow core optical fibres particularly attractive for use in telecommunications applications, in which data is carried by optical signals between two transceiver stations remote from one another. To enable telecommunications between widely separated transceiver stations, such as transoceanic telecommunications, very long lengths of optical fibre are needed. The low loss offered by hollow core optical fibre makes it very well-suited for such configurations. Existing solid core optical fibre fabrication technology can produce continuous spans of hundreds of kilometre lengths, but as noted above, achievable yield lengths for hollow core fibres are currently much shorter. Therefore, in order to exploit the superior properties of hollow core optical fibres for long-haul telecommunications it is at present necessary to splice multiple lengths of fibre end-to-end, introducing undesirable losses at each splice which mitigate the inherent low loss of the fibres.

Accordingly, approaches which are able to increase the yield of hollow core optical fabrication are of interest.

### SUMMARY OF THE INVENTION

Aspects and embodiments are set out in the appended claims.

According to a first aspect of certain embodiments described herein, there is provided a hollow core optical fibre configured for guidance of an optical wave by antiresonance, comprising: a tubular glass jacket with a central lumen and a wall with a wall thickness; a hollow core defined in the central lumen and having in transverse cross-section a polygonal shape; and a cladding located in the central lumen and comprising flat planar glass membranes each having two opposite edges extending along a length of the hollow core optical fibre and a membrane thickness less than the wall thickness, the glass membranes arranged as a plurality of groups of glass membranes, each group comprising: a core boundary glass membrane defining one side of the polygonal shape of the hollow core; and at least one cladding glass membrane located between the core boundary glass membrane and the tubular glass jacket, all glass membranes in the group being spaced apart from one another; wherein every side of the polygonal shape of the hollow core is formed by a core boundary glass membrane, every glass membrane is anchored to the tubular glass jacket only along its two opposite edges, and there is no contact between any of the glass membranes.

According to a second aspect of certain embodiments described herein, there is provided a preform for fabricating a hollow core optical fibre configured for guidance of an optical wave by antiresonance according to claim 1, the preform comprising: a plurality of hollow glass tubes with walls each having a thickness, and of decreasing diameter arranged concentrically one inside another with spaces between the hollow glass tubes, to provide the flat planar glass membranes of the hollow core optical fibre; an outer hollow glass tube arranged concentrically around, and spaced apart from, the plurality of hollow glass tubes, and having a wall of a thickness greater than the thickness of each of the walls of the hollow glass tubes, to provide the tubular glass jacket of the hollow core fibre; and three or more groups of glass spacer elements, the groups spaced circumferentially apart around the preform in correspondence with corners of the polygonal shape of the hollow core of the hollow core fibre, the spacer elements in each group comprising at least one spacer element in each space between the hollow glass tubes and the outer hollow glass tube.

According to a third aspect of certain embodiments described herein, there is provided a method of making a preform for fabricating a hollow core optical fibre configured for guidance of an optical wave by antiresonance, the preform according to the second aspect, the method comprising: a first stage comprising making a partial assembly by arranging a plurality of hollow glass tubes with walls each having a thickness and of decreasing diameter concentrically inside one another with spaces between the hollow glass tubes, and arranging glass spacer elements in the spaces between the hollow glass tubes, the spacer elements arranged in at least three groups which are spaced circumferentially about the hollow glass tubes, the spacer elements in each group comprising at least one spacer element in each space between the hollow glass tubes; a second stage comprising drawing the partial assembly down to reduce its diameter and consolidate the hollow glass tubes with the spacer elements; a third stage comprising optionally arranging further hollow glass tubes and further glass spacer elements around the partial assembly if more hollow glass tubes are required in the preform, the further glass spacer elements aligned with the groups in the partial assembly; and a fourth stage comprising arranging any further hollow glass tubes required in the preform concentrically around the partial assembly, and arranging an outer hollow glass tube with a wall of a thickness greater than the thickness of each of the walls of the hollow glass tubes concentrically around an outermost of the hollow glass tubes with a space between, and arranging still further glass spacer elements in each space between the hollow glass tubes and the outer hollow glass tubes, the still further glass spacer elements aligned with the groups in the partial assembly.

According to a fourth aspect of certain embodiments described herein, there is provided a method of fabricating a hollow core optical fibre configured for guidance of an optical wave by antiresonance, the method comprising: heating and drawing a preform according to the second aspect to form an optical fibre.

These and further aspects of certain embodiments are set out in the appended independent and dependent claims. It will be appreciated that features of the dependent claims may be combined with each other and features of the independent claims in combinations other than those explicitly set out in the claims. Furthermore, the approach described herein is not restricted to specific embodiments such as set out below, but includes and contemplates any appropriate combinations of features presented herein. For example, devices and methods may be provided in accordance with approaches described herein which includes any one or more of the various features described below as appropriate.

### BRIEF DESCRIPTION OF THE DRAWINGS

For a better understanding of the invention and to show how the same may be carried into effect reference is now made by way of example to the accompanying drawings in which:

FIG. 1 shows a transverse cross-sectional view of a first known antiresonant hollow core optical fibre;

FIG. 2 shows a transverse cross-sectional view of a second known antiresonant hollow core optical fibre;

FIGS. 3A to 3H show transverse cross-sectional views of eight known hollow core optical fibres with assorted internal structures;

FIG. 4 shows a transverse cross-sectional view of a first example antiresonant hollow core optical fibre according to the present disclosure, having a triangular hollow core;

FIG. 5 shows a transverse cross-sectional view of a second example antiresonant hollow core optical fibre according to the present disclosure, having a square hollow core;

FIG. 6 shows a transverse cross-sectional view of a third example antiresonant hollow core optical fibre according to the present disclosure, having protruding portions and sink cavities for higher order optical modes;

FIG. 7 shows a transverse cross-sectional view of a fourth example antiresonant hollow core optical fibre according to the present disclosure, having a triangular core and protruding portions;

FIG. 8 shows a transverse cross-sectional view of a fifth example antiresonant hollow core optical fibre according to the present disclosure, having sink cavities for higher order optical modes;

FIG. 9 shows a graph of computer-modelled variation of optical loss with increasing antiresonant membrane number for example antiresonant hollow core optical fibres according to the present disclosure;

FIG. 10 shows a transverse cross-sectional view of a first example preform for fabricating an antiresonant hollow core optical fibre according to the present disclosure; and

FIG. 11 shows a transverse cross-sectional view of a second example preform for fabricating an antiresonant hollow core optical fibre according to the present disclosure.

### DETAILED DESCRIPTION

Aspects and features of certain examples and embodiments are discussed/described herein. Some aspects and features of certain examples and embodiments may be implemented conventionally and these are not discussed/described in detail in the interests of brevity. It will thus be appreciated that aspects and features of devices and methods discussed herein which are not described in detail may be implemented in accordance with any conventional techniques for implementing such aspects and features.

Hollow core optical fibres have a cross-sectional structure (transverse to the length of the fibre) comprising a central hollow void or lumen providing a core along which a fundamental optical mode is guided or propagated, surrounded by a microstructured cladding comprising a plurality of smaller voids or lumens having an arrangement or configuration that supports waveguiding of the fundamental optical mode by one or another physical phenomenon. The voids of the cladding are separated or divided from one another and from the core by thin glass membranes, walls or struts. A thicker bulk glass tubular outer jacket surrounds and supports the cladding. Hollow core fibres can be categorised according to their mechanism of optical guidance into two principal classes or types: hollow core photonic bandgap fibre (HCPBF, alternatively referred to as hollow core photonic crystal fibre, HCPCF), and antiresonant hollow core fibre (AR-HCF or ARF). In HCPBF, the structured cladding comprises a regular closely packed array of lumens formed from many small glass capillaries, from which a central group is excluded to define a substantially circular hollow core. The periodicity of the cladding structure provides a substantially periodically structured refractive index and hence a photonic bandgap effect that confines the propagating optical wave towards the core. In ARF, the structured cladding comprises a much lower number of larger glass lumens with an overall structure lacking a high degree of periodicity so that photonic bandgap effects are not significant, but with some periodicity on a larger scale since the lumens are generally located regularly. The cladding structure provides antiresonance for propagating wavelengths which are not resonant with a wall thickness of the cladding lumens, in other words, for wavelengths in an antiresonance window which is defined by the thickness of the walls or membranes defining the cladding lumen. The cladding lumen surround the central void or cavity which provides the hollow core of the fibre, and which is able to support antiresonantly-guided optical modes. The structured cladding can also support cladding modes able to propagate primarily inside the lumens, in the glass of the lumen walls or in spaces or interstices between the cladding lumen and the fibre's outer jacket. The loss of these additional non-core guided modes is generally very much higher than that of the core guided modes. The fundamental core guided mode typically has by far the lowest loss amongst the core guided modes. The antiresonance provided by a lumen wall thickness which is in antiresonance with the wavelength of the propagating light acts to inhibit coupling between the fundamental core mode and any cladding modes, so that light is confined to the core and can propagate at very low loss.

A large variety of antiresonant designs have been proposed in recent years. Designs of particular interest, which are amenable to fabrication by drawing from a preform over at least intermediate lengths, are comprised of a series of tubes or capillaries, typically of circular cross-section, arranged around the inner surface of a hollow circular tubular outer jacket so as to leave an empty space in the centre of the outer jacket to act as the core.

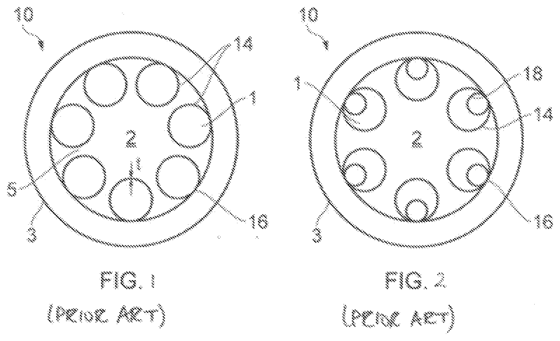

FIG. 1 shows a cross-sectional view of an example of a known simple antiresonant hollow core fibre structured in this way. The fibre 10 has an outer tubular cladding or jacket 3 comprising a wall defining a central lumen. The structured (inner) cladding 1 comprises a plurality of tubular cladding capillaries 14, in this example seven capillaries of the same cross-sectional size and shape, which are arranged inside the jacket 3 in a single ring, so that the longitudinal axes of each cladding capillary 14 and of the jacket 3 are substantially parallel. Each cladding capillary 14 is in contact with (bonded to) the inner surface of the jacket 3 at a location 16, such that the cladding capillaries 14 are evenly spaced around the inner circumference of the jacket 3, and are also spaced apart from each other by gaps 5 (there is no contact between neighbouring capillaries). In some designs of ARF, the cladding tubes 14 are positioned in contact with each other (in other words, not spaced apart as in FIG. 1). Such points of contact between walls or membranes defining cladding lumen are referred to as nodes, and tend to cause undesirable resonances that result in high losses, so the elimination of nodes, such as by the spacing apart in FIG. 1, can improve the fibre's optical performance. Accordingly, fibres with spaced-apart cladding capillaries may be referred to as “nodeless antiresonant hollow core fibres”.

The arrangement of the cladding capillaries 14 in a ring around the inside of the tubular jacket 3 creates a central space, cavity or void within the fibre 10, also with its longitudinal axis parallel to those of the jacket 3 and the capillaries 14, which is the fibre's hollow core 2. The core 2 is bounded by the inwardly facing parts of the outer surfaces of the circular cladding capillaries 14. This is the core boundary, and the material of the capillary walls or membranes that make up this boundary provides the required antiresonance optical guidance effect or mechanism. The capillaries 14 have a thickness t at the core boundary which defines the wavelength for which antiresonant optical guiding occurs in the antiresonance fibre. This thickness t is considerably less than the thickness of the wall of the jacket 3. The curvature of the cladding capillaries is convex or inward from the point of view of the core 2, so the core boundary is referred to as having a negative curvature. A negative curvature structure is widely considered to be important in achieving low loss in a hollow core fibre.

FIG. 2 shows a transverse cross-sectional view of a second known example negative curvature antiresonant hollow core fibre formed from circular tubular capillaries. This fibre 10 has a structured inner cladding 1 comprising six cladding capillaries 14 evenly spaced apart around the inner surface of a tubular outer jacket 3 and surrounding a hollow core 2. A difference from the FIG. 1 example is that each cladding capillary 14 has a secondary, smaller capillary 18 nested inside it, bonded to the inner surface of the cladding capillary 14, in this example at the same azimuthal location 16 as the point of contact between the primary capillary 14 and the jacket 3. These additional smaller capillaries 18 can reduce the optical loss. Additional still smaller tertiary capillaries may be nested inside the secondary capillaries 18. Antiresonant fibre designs of this type, with secondary and optionally smaller further capillaries, may be referred to as “nested antiresonant nodeless fibres”, or NANFs [3].

The nested configuration introduces additional membranes between the core and the jacket. These extra layers increase the antiresonant effect and therefore reduce the optical loss experienced by the fundamental mode propagating in the core, improving the performance of the optical fibre. Multiple spaced-apart membranes arranged sequentially between the core and the jacket are accordingly considered as a beneficial feature in hollow core optical fibres. However, the provision of this feature by way of circular capillaries as in the FIGS. 1 and 2 designs leads to fabrication complications because different pressurisation has to be applied to the various capillaries during fibre drawing in order to maintain their shapes. Ultimately this results in substantial fabrication difficulties because the dynamic between the differential pressures and surface tension in the softened glass of the fibre preform results in overexpansion of some lumen and subsequent distortions in the finished fibre structure. The achievable span of hollow core fibre that can be drawn is therefore limited, and the exceptional performance characteristics of the fibre are not available at their optimum for long length applications such as telecommunications.

A variety of other designs of hollow core optical fibre have been proposed elsewhere. However, the aim of the designs is often to provide a fibre with very low optical propagation loss, and little consideration is given to the practicalities of manufacture.

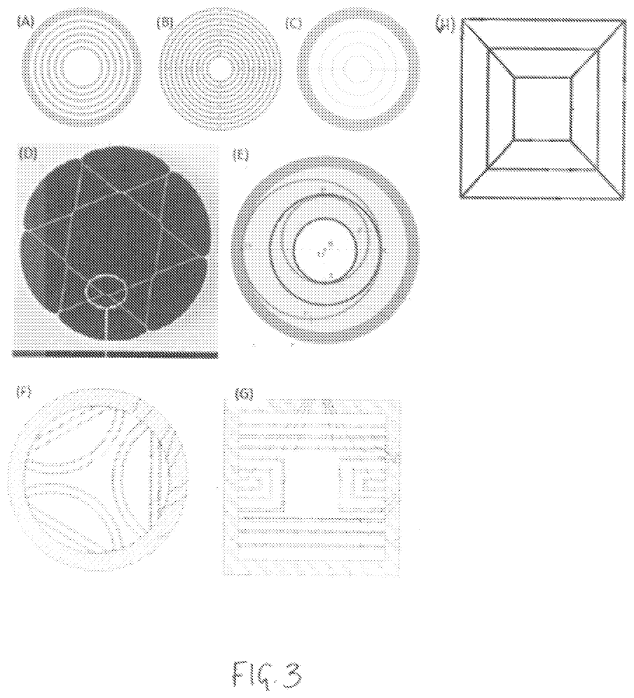

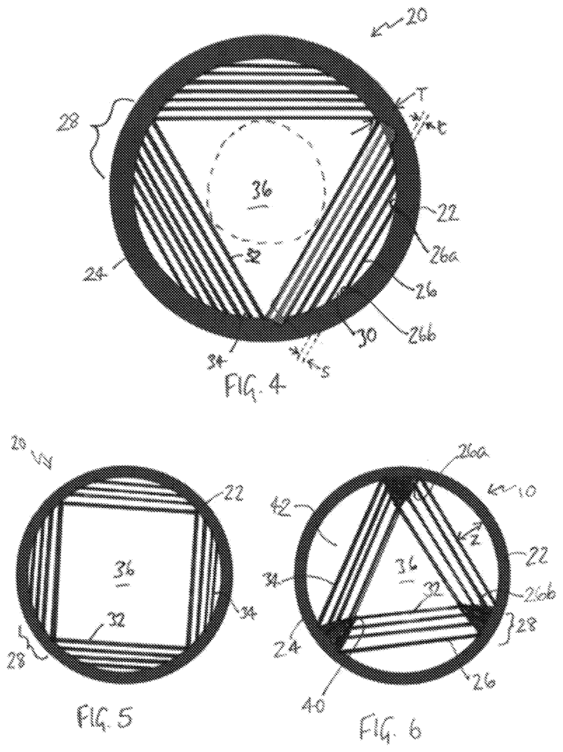

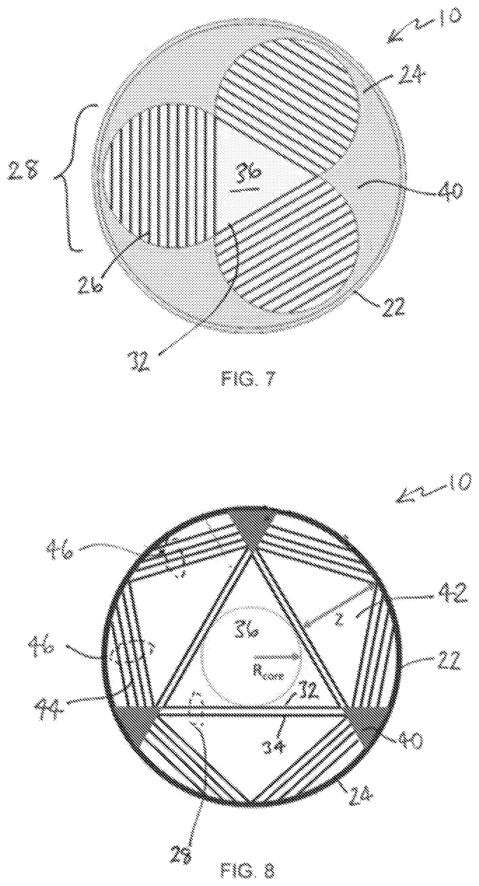

FIG. 3 shows a selection of known hollow core optical fibre designs (in transverse cross-section), many with multiple layers of cladding membranes intended to provide low loss, but all presenting various problems as regards manufacture or optical performance. FIG. 3A shows a design in which the cladding comprises a plurality of concentric circular membranes of increasing size arranged between the core and a circular jacket [4]. The fibre is actually designed as a Bragg grating fibre but a configuration in which the concentric membranes are unattached and floating as depicted is not possible to fabricate so in reality the cladding has a solid configuration of concentric dielectric layers. FIGS. 3B and 3C show similar designs of concentric circular cladding membranes, in this case supported by radial struts between the membranes [5, 6]. Such designs, intended for terahertz applications, are producible using 3D printing or extrusion, but would deform significantly if made by drawing from a preform. Fibre length is therefore limited. FIG. 3D shows an early design of antiresonant hollow core optical fibre [7]. It can be drawn from a preform assembled from circular capillaries using a single pressure which causes the curved walls of the capillaries to flatten under surface tension, creating a hexagonal core, but lacks multiple membrane layers in the cladding, and has nodes (circled in the Figure) formed where membranes are in contact, so has high optical loss. FIG. 3E shows a design with multiple non-concentric circular cladding membrane layers which are in contact at various offset positions [8]. The contact is to provide support for the membranes, removing the difficulties of the floating design of FIG. 3A. However, the contact points create nodes, introducing resonance loss. Also, the complex and curved structure would require multiple different pressurisation zones during fibre drawing, and would probably still deform considerably. FIG. 3F shows a design in which a roughly triangular hollow core is bounded by azimuthally spaced-apart parallel pairs of inwardly curving membranes [9]. The curvature requires differential pressures for fibre drawing so achievable spans are limited in the same manner as the designs of FIGS. 1 and 2. FIG. 3G shows a design having a square hollow core and a square jacket, the cladding formed from layered parallel non-curved membranes [10]. Some membranes include 90 degree angles which would distort to curved shapes during fibre drawing, even under differential pressures, so successful fabrication would be restricted to 3D printing and achievable lengths would therefore be very limited. FIG. 3H shows another square design in which concentric square cladding membranes are supported by strut membranes at their corners [11]. The struts create nodes at their junctions with the cladding membranes and so will cause resonant losses, so fibre performance is compromised.

The present disclosure proposes an antiresonant hollow core fibre structure that eliminates loss-causing nodes and which can, if desired, be drawn using a single pressure in all voids or lumens within the fibre so that fibre drawing can be upscaled compared to currently attainable processes, allowing much longer lengths of quality fibre with consistent structure to be achieved than is possible with existing designs.

These goals are addressed by the use only of flat planar glass membranes to define the cladding. The flatness eliminates voids or lumens which are bounded by curved membranes, and this allows a single pressure to be applied during drawing of the fibre. In the originating preform, membranes can be flat or curved; the application of the same pressure throughout the fibre allows the softened glass membranes to remain flat or become flattened under the action of surface tension so that the desired flat membranes are present in the finished drawn fibre. A single pressure enables a simple dynamic during the drawing process in which the whole microstructure expands and contracts together, and reduces or avoids the complex interplay of pressures and surface tension that arises when multiple pressures are necessary to maintain curved shapes. This avoids limitations imposed by the need to avoid the overexpansion and structural distortion that differential pressurisation produces in an extended fibre draw, and enables the production of very long lengths of fibre from a single draw. The membranes of the preform have an appropriate thickness or thicknesses so that when thinned by the drawing process the final membrane thickness(es) in the fibre provides antiresonance at the intended wavelength(s) of light to be propagated by the optical fibre. In contrast, the outer glass jacket which surrounds and supports the cladding structure has a much greater thickness that is able to withstand distortion from surface tension during the draw, so can be curved and still maintain its shape despite the use of a non-differential pressure. Usefully, therefore, the outer jacket can have a hollow tubular shape of circular cross-section, in line with conventional optical fibre design, although this is not essential. The wall of the jacket (in both the preform and the finished fibre), which defines a hollow central lumen in which the cladding is located, has a thickness which is greater than (generally significantly greater than) the thickness(es) of the membranes, and which does not provide any antiresonance effects for the propagating wavelength. The jacket may be considered to be formed from bulk glass, owing to its greater thickness compared to the membranes. Note that while the ability to fabricate the proposed fibres using non-differential pressurisation is a useful advantage, the fibres may also be drawn using differential pressure if preferred.

In addition, the flat planar glass membranes in the optical fibre are supported within the jacket by being anchored (secured, bonded or otherwise in contact with) to the jacket only along their two opposite edges which are parallel to the longitudinal extent, or length, of the fibre, and there are no contact points between any of the glass membranes. Every membrane is in contact with (anchored to) the inner surface of the wall of the jacket, and is not in contact with any other membrane. This configuration eliminates nodes, which as noted above are sources of propagation loss in a hollow core antiresonant microstructured optical fibre. Hence, the proposed structure is able to be fabricated as extended lengths of low loss, high performance optical fibre. At present the output of hollow core fibre is limited to around only 10 km per preform. The structure proposed herein is much more tolerant to increases in yield owing to the absence of microstructure deformation when production is upscaled. It is anticipated that the production rate could be increased by an order of magnitude or more. This will not only provide much more useful extended spans of fibre, but will also reduce costs; current hollow core fibre being extremely expensive due to the fabrication limitations. Applications such as transoceanic optical fibre links between telecommunications data centres, requiring many thousands of kilometres of fibre in a cable, become highly feasible.

The flat planar glass membranes necessarily prevent the hollow core of the proposed fibres having a negative curvature core boundary. However, contrary to popular understanding in the field that negative curvature is of key importance for low loss operation, it has been found that comparable operation can be achieved by appropriate configuration of the membranes. In place of a negative curvature core boundary, the flat membranes define, in transverse cross-section through the fibre, straight sides for the core boundary, so that the core has a polygonal shape formed from a plurality of straight sides. The polygon may or may not be regular, although the symmetry of a regular polygonal shape can improve waveguiding performance. In the proposed designs, the core is defined and bounded exclusively by the flat membranes, so that every side of the polygon is formed by a glass membrane, and there are no intermediate sides provided by parts of the inner surface of the wall of the jacket (noting that some minor deviation from this may arise in an actual fibre owing to surface tension effects and fabrication errors at the apexes of the polygon, but this is not significant in effect, and is not an intended feature of the fibre design).

FIG. 4 shows a transverse cross-sectional view through a first example hollow core optical fibre as proposed herein. The hollow core optical fibre 20 comprises a tubular glass jacket 22 with a circular transverse cross-sectional shape, formed from an outer wall 24 of bulk (solid) glass that surrounds and encloses a central hollow space or void (lumen). The wall has a thickness T. Within the central lumen of the jacket 22 is located the cladding of the fibre 20, comprised of a plurality of planar flat glass membranes 26. Each membrane 26 has a thickness t less than the thickness T of the jacket wall 24, and selected for antiresonance with the wavelength(s) which the fibre 20 is intended to propagate. The membranes 26 may or may not all have the same thickness. The membranes 26 extend along the length of the fibre 20 orthogonal to the transverse cross-section (so, as depicted, into the plane of the page), and have two edges 26a, 26b opposite to one another that are parallel to this orthogonal direction, the plane of the flat planar shape of each membrane 26 extending between the two opposite edges 26a, 26b. For ease of understanding and description, the membranes 26 can be considered as being arranged into a plurality of groups 28 of membranes. In this example, there are three groups 28 of membranes 26. Each group 28 comprises at least two membranes 26, and in this particular example each group 28 comprises seven membranes 26. The groups 28 are arranged sequentially around the circumference of the jacket 22, within the central lumen. The membranes 26 making up each group 28 are arranged in a layered stack within which the individual membranes are spaced apart from one another by a spacing or gap 30 of depth s (in a direction normal to the planes of the membranes 26), the membranes 26 in a group 28 being substantially parallel to one another. Within each group 28, the membranes 26 comprise a core boundary membrane 32 which is closest to the centre of the central lumen within the jacket 22, and one or more (in this example, six) cladding membranes 34 arranged in their spaced apart positions one behind the other along the radial direction between the core boundary membrane 32 and the inner surface of the jacket 22. In this example, the spaced apart cladding membranes 34 occupy substantially all the space behind their corresponding core boundary membrane 32. Every membrane 26 in every group 28 (so, both the core boundary membranes 32 and the cladding membranes 34) is in contact with (anchored to, secured to, bonded to) the inner surface of the wall 24 of the jacket 22 along both of its two opposite edges 26a, 26b. This contact between the edges 26a, 26b of the membranes 26 and the jacket 22 only, and the spaced apart arrangement of the membranes 26 means that none of the membranes 26 touch one another (there is no contact between any membranes). Hence, there are no loss-causing nodes in the cladding structure.

The fibre 20 has a hollow core 36 defined in the central lumen of the jacket 22. The arrangement of the membranes 26 into groups around the jacket's perimeter means that the core 36 is bounded by the core boundary membranes 32, and since the core boundary membranes are flat (defining a straight line in the transverse cross-section of the fibre 20), the hollow core 36 has a polygonal transverse cross-sectional shape, where each side of the polygon is formed by one of the core boundary membranes 32. The core boundary membranes 32 have a width and are positioned within the jacket 22 such that the adjacent edges of adjacent core boundary membranes 32 are anchored with the jacket 22 immediately next to one another with no intervening portion of the inner surface of the jacket 22 exposed to the region forming the core 36. Hence, every side of the polygonal shape of the hollow core 36 is formed by one core boundary membrane 32. Since this example has three groups 28 of membranes, there are three core boundary membranes 32 and the polygonal shape of the hollow core 36 is a triangle.

In the example of FIG. 4, each group 28 of membranes comprises an equal number of membranes 26. This is not essential, and different groups 28 may have different numbers of membranes 26, although equality gives a symmetrical design which aids waveguiding. Although seven membranes 26 per group 28 are shown, smaller or large numbers may be included, for example in the range of two to twenty membranes per group, although large numbers are not excluded. The number of membranes 26 used may depend on the membrane thickness t and the available space behind each core boundary membrane 32 which is available for accommodating the cladding membranes. A large number of membranes 26 per group 28 improves the optical performance since each additional layer increases the antiresonant effect, and reduces the propagation loss of the fundamental optical mode. This is explained further later.

Similarly, the symmetry of the design can be bolstered by arranging the membranes 26 within each group 28 to be parallel to one another, as depicted in FIG. 4, although this is not essential. Also, the membranes 26 in each group 28 may be spaced apart by spaces 30 which are all of equal depth, and/or the spaces 30 within a group 28 may have the same depth as the spaces 30 in each of the other groups 28. Again, equal spaces are not essential, and different depths of spacing may be used within a group 28 or across the groups 28.

Regarding the shape of the hollow core, this may be a regular polygon if all the core boundary membranes 32 have the same width (distance between the two opposite edges 26a, 26b), so that every side of the polygonal shape has the same length. Alternatively, the core boundary membranes 32 may have differing widths to provide an irregular polygonal shape for the core 36.

The triangular shape of the hollow core 36 in the FIG. 4 example can be beneficial in that a triangle allows the corners or vertices of the core 36 to be as remote as possible from a nominal circular region in the centre of the core 36 that extends between the core boundary membranes 32, indicated by a dotted line in FIG. 4. The radius of this circle can be designated as a core radius, for the purpose of characterising the optical fibre and comparing with other fibre designs. This is the region along which the bulk of the fundamental optical mode will propagate, and distancing the corners of the hollow core space from this can also contribute to a reduced optical loss. However, the proposed hollow core design is not limited in this regard.

FIG. 5 shows a transverse cross-sectional view through a second example hollow core optical fibre 20. In this example, there are four groups 28 of membranes 26, so that the hollow core 36 has a four-sided polygonal shape in cross-section. Each of the core boundary membranes 32 has the same edge-to-edge width, so the polygonal shape is a square. Each group 28 comprises four membranes 26 in this example, although as discussed above other numbers of membranes may be used. However, a larger number of groups 28 and hence a larger number of sides to the core tends to reduce the available space between each core boundary membrane 26 and the jacket 22, so that a lesser number of cladding membranes 34 may be accommodated in each group 28. For this reason, a triangular core may be preferred as enabling more antiresonant layers in the cladding and hence a reduced propagation loss.

The examples of FIGS. 4 and 5 each show the membranes 26 connected at their edges with the inner surface of the jacket, where the jacket has a smooth inner surface and a constant wall thickness. In other configurations, the jacket can be differently configured, in that it has a number of inwardly directed protrusions to which the edges of the membranes are contacted.

FIG. 6 shows a cross-sectional view of a third example fibre. In this example, the jacket 22 of the fibre 10 has three protrusions or protruding portions 40 which protrude inwardly into the central lumen of the jacket 22. The protruding portions are unitary with the glass of the wall 24 of the jacket, so are also bulk solid glass, and have dimensions generally greater than the thickness of the membranes 26. This avoids interference with the antiresonant guidance by resonance (like a node) or antiresonance. Three groups 28 of membranes 26 comprise the cladding, so that the hollow core 36 has a triangular shape as in the FIG. 4 example, with the core boundary membrane 32 of each group forming one side of the hollow core 36. The edges of each membrane 26 are, as before, anchored to the jacket 22, but in this example the anchoring contact is made at the protruding portions 40, with each group 28 disposed between a pair of adjacent protruding portions 40, and the edges 26a, 26b of each membrane contacting the protruding portions 40. Hence, the protruding portions 40 are aligned with the corners of the polygonal shape of the hollow core 36, in this case the vertices of the triangle. For other polygonal shapes, a corresponding number of protruding portions for each vertex and groups of membrane for each side can be used instead.

It can be observed from FIG. 6 that the membranes 26 are all connected with sides of the protruding portions 40, over the full height of protruding portions. Alternatively, in order to provide more membrane layers, extra cladding membranes can be included behind those shown in FIG. 6, with their edges anchored to the curved portions of the inner surface of the jacket wall 24 between the protruding portions 40, as in FIGS. 4 and 5; the space between the core boundary membranes 32 and the wall 24 can be fully occupied as shown before. Additional membranes may also be accommodated by increasing the height of the protruding portions 40 so that they extend further into the central lumen of the jacket 22; this gives more room along the height of the protruding portions 40 for the securing of membrane edges.

Otherwise, however, an empty space can be left behind each group 28 of membranes 26 (with or without the use of protruding portions), as shown in FIG. 6. This creates a cavity 42 between each group 28, behind the rearmost or outermost (along the radial direction) cladding membrane 34 in each group 28, and the wall 24 of the jacket 22. The cavities have a depth z in the radial direction which is greater than, typically several or many times greater than, the spacing s between the membranes 26 in its associated group 28. These cavities act as “sinks” for higher order propagating optical modes, which act to suppress higher order modes by allowing the energy carried by such modes to decay by experiencing significant propagation loss. This allows for the majority of the optical power propagating in the fibre to be concentrated in the fundamental mode propagating in the core, for improved optical performance of the fibre. Suppression of higher order modes can be important for some applications. For example, in telecommunications, power can be coupled out of the fundamental mode and into higher order modes at splices and other interruptions along a fibre's length. The modes may experience different propagation speeds, and if allowed to remain and propagate to the receiving station, the portion of the signal carried by the higher order modes can interfere with the fundamental mode and decrease the signal to noise ratio.

In alternative designs, a cavity to provide a sink for higher order optical modes can be implemented by arranging the membranes in a group such that one of the spacings between adjacent membranes is significantly larger than the other spacings. Any of the spacings may be enlarged or widened in this way to provide a sink cavity, including the space between the core boundary membrane and the innermost cladding membrane.

The protruding portions can take any convenient shape and protrude as little or as much into the lumen of the jacket as is convenient for supporting the required number of membranes in each group. The shape of the protruding portions may be an end result of the surface tension effects in the fibre during drawing. The protruding portions may be integrally formed with the jacket used in the originating preform for the fibre and be intended to keep the same or similar shape during drawing and into the finished fibre, or may adopt a different shape under surface tension during drawing, or may be created by the fusing of two or more smaller portions of glass during drawing.

FIG. 7 shows a transverse cross-sectional view of an other example hollow core optical fibre. In this fibre 10, the protruding portions 40 are of a greater extent both radially and circumferentially than the FIG. 6 example, in that they have a greater height above the basic thickness of the jacket wall 24, and reach further around the circumference of the wall 24, meeting up at their bases with the adjacent protruding portions. The side surfaces of the protruding portions 40 are curved, and therefore define a concave space or recess between each protruding portion. A group 28 of membranes 26 is located in each recess, with the core boundary membranes 32 extending between the tips of the protruding portions 40 to bound and define the hollow core 36. Three protruding portions and three groups 28 are included, so that the hollow core is again triangular. Each group 28 comprises twelve membranes in this example, which can be accommodated by the greater height of the protruding portions 40, and the membranes 26 fill the recesses between the protruding portions 40 so that there are no sink cavities. Membranes 26 might be omitted at the rear of each stack, however, to provide sink cavities as in FIG. 6 if desired, or within each stack to provide a sink cavity in the form of a wider membrane spacing, as noted above.

FIG. 8 shows a cross-sectional view of a still other example optical fibre. Similarly to the FIG. 6 example, this fibre 10 has three protruding portions 40, and three groups 28 of membranes 26 connected to the wall 24 of the jacket 22 at the sides of the protruding portions 40, so as to define a triangular shape for the hollow core 36, the core radius R of which is indicated. Each group 28 comprises only two membranes in this example, being one core boundary membrane 32 and one cladding membrane 34. Accordingly, there is a significant space remaining between each group 28 and the jacket 22; this provides higher order mode sink cavities 42 of radial depth z behind the cladding membranes 34, as discussed above for FIG. 6. In addition, the fibre 10 of FIG. 8 comprises secondary flat planar glass membranes 44, which are associated with the sink cavities 42. The secondary membranes 44 are located behind the sink cavities 42, so as to be located between the sink cavities 42 and the inner surface of the jacket wall 24. Each cavity 42 has secondary membranes 44 associated with it, and the secondary membranes 44 form an outermost (in the radial direction) boundary of the sink cavities 42, in place of the jacket wall 24 as in the FIG. 6 example. In general, each sink cavity 42 can be provided with at least two secondary membranes, which are spaced apart from one another by gaps in the manner already discussed for the groups 28 of glass membranes. The secondary membranes 44 might be, for example, positioned substantially parallel to the glass membranes in the groups 28, but spaced apart from the outermost cladding membranes 34 by the sink cavity, thereby providing a sink cavity in the form of a wider spacing between parallel membranes as described above. FIG. 8 shows an alternative arrangement, however, in which the secondary membranes 44 associated with each cavity 42 are themselves arranged into groups 46 of secondary membranes 44. The FIG. 8 example shows two groups 46 of secondary membranes 44, but more groups may be included if desired. Within each group 46, the secondary membranes are arranged spaced apart from one another. In FIG. 8, each group 46 comprises four secondary membranes 44, but fewer or more secondary membranes may be included, perhaps dictated by available space within the cavity, a desire to limit complexity of fibre fabrication, or to tailor optical characteristics of the fibre 10. The grouping and positioning of the groups 46 of secondary membranes 44 is such that an innermost (in the radial direction) of the secondary membranes 44 in each group 46 forms one side of a cross-sectional shape of the cavity 42. The cavity 42 is bounded only by glass membranes, so that its shape has all sides defined by the outermost of the cladding membranes 34 in the relevant group of membranes 28 and the innermost of the secondary membranes in each group 46 (subject to any deviations in position arising during fibre fabrication so that the jacket wall 24 and/or the protrusions 40 may form negligible parts of the boundary of the cavity. This may similarly arise for the shape of the core 36). Since in this example, each cavity 42 has two groups 46 of secondary membranes 44 associated with it, the cavities 42 have three sides and triangular cross-sectional shape. In the FIG. 8 example, each secondary membrane is anchored to the jacket wall 24 by having one of its edges anchored to a protruding portion 40 and the other of its edges anchored to the inner surface of the intermediate portion of the jacket wall 24, between to adjacent protruding portions 40. For each cavity 42, one group 46 of secondary membranes has edges anchored to one of the two protruding portions 40 between which the cavity 42 is located, and the other group 46 of secondary membranes 44 has edges anchored to the other of the two protruding portions 40. Secondary membranes 44 may be implemented in configurations lacking protruding portions, however.

The secondary membranes act to reduce light leakage from the core. The path of leakage will include routes to the protrusions which can be reduced by closely spaced membranes. Also, flexibility in the positioning of the secondary membranes allows the size of the sink cavity to be tailored, thereby offering control over which higher order core mode will couple out of the more most strongly.

It has been noted above that good optical performance is attainable from the hollow core antiresonant optical fibres proposed herein, despite the absence of a negative curvature hollow core. Also noted is the improved performance arising from increasing the number of spaced apart glass membranes in each group. This adds additional layers to the antiresonant structure, increasing the antiresonant effect that enables optical guidance, thereby increasing confinement of the fundamental mode in the hollow core and correspondingly reducing the amount of optical loss experienced by propagating light. The size(s) of the spacings between the membranes may also contribute to optical performance.

FIG. 9 shows a graph of results of computer modelling performed to investigate the effect of membrane number on optical loss. The horizontal axis shows the total number of glass membranes N included in each group (so, associated with each side of the polygonal hollow core), for a range of two membranes up to sixteen membranes. Partial depictions of examples fibres with two membranes and sixteen membranes are included in the Figure, for which it can be seen that the modelled fibres have a triangular hollow core and are configured with protruding portions and without higher order mode sink cavities, like the example of FIG. 7. The vertical axis shows optical loss (designated as confinement loss) in dB/km. The graphs plots two lines. Line 48 shows loss for the fundamental optical mode, from which it can be appreciated that the addition of more membranes significantly reduces the optical loss, with a reduction of five orders of magnitude achieved by increasing from two to sixteen membranes. Line 50 shows loss for higher order optical modes, from which it can been seen that a similar level of reduction in loss is produced by changing from two to sixteen membranes. Recall that the modelled fibres have no higher order mode sink cavities so there is no suppression of higher order modes; loss levels for the higher order modes would be expected to be much greater for fibres with sink cavities. The lack of a sink cavity means that in each example, the membrane groups occupy the same space between the core and the wall, so that the spacing between membranes decreases with the number of membranes. Hence, the results shown in FIG. 9 may also be understood as showing that the reduction of the membrane spacing reduces the optical loss.

The number of membranes can be selected according to required loss levels, where there may be a need to balance the increased complexity of fibre structure and hence of fibre fabrication arising from higher membrane numbers against acceptable amounts of loss. For applications where low loss is of high importance, the number of membranes may be chosen to be eight or above, for example. Eight membranes gives a loss of about 1 dB/km, while 14 membranes can give a loss of about 0.2 dB/km, comparable to the loss of conventional telecommunications optical fibre.

It has also been observed that membranes located nearer to the core are more significant for loss reduction. If the same, narrow, membrane spacing is used as in the N=16 example in FIG. 9, the same performance can be achieved with just the six innermost membranes near the core.

As mentioned, an important aspect of the proposed hollow core fibre configurations is that they can withstand fibre drawing using only a single pressure applied to all the voids in the preform, with a differential pressure regime not being necessary. This simplifies the draw process and enables greatly increased lengths of fibre to be drawn compared with current hollow core fibre designs that require differential pressurisation. Optical fibres are typically manufactured by drawing the fibre from a heated preform, in a fibre drawing tower. Accordingly, a suitable preform is required which is able to generate the intended fibre structure during the draw process. One way to achieve this is to use a preform which replicates the intended fibre structure, so that the draw process simply shrinks the cross-sectional dimensions of the preform down to the required dimensions of the finished fibre. Alternatively, a preform of a different cross-sectional geometry can be used, since the action of surface tension in the softened glass during the draw, in the absence of competing differential pressures, will act to flatten thin portions of glass, thereby creating the desired flat planar glass membranes. In this way, curved glass elements can be included in the preform, and flattened during the draw. A benefit of this is that preform fabrication can be based on existing techniques for making hollow core optical fibre preforms in which cylindrical glass tubes or capillaries are assembled together to make preforms for fibre designs with circular elements such as the designs of FIGS. 1 and 2. The term “stack and draw” is used for these techniques, since a plurality of tubes, and sometimes solid rods, are stacked in the appropriate configuration inside a tube for the outer jacket, and then drawn into the fibre, possibly via an intermediate cane.

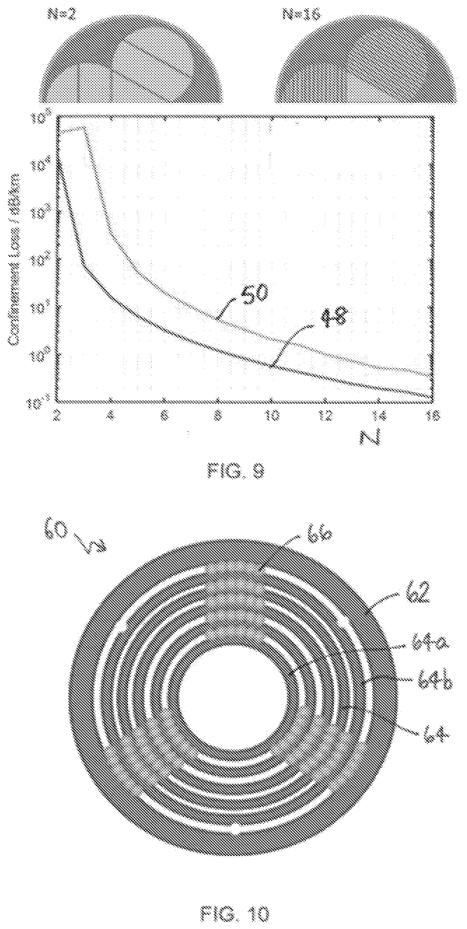

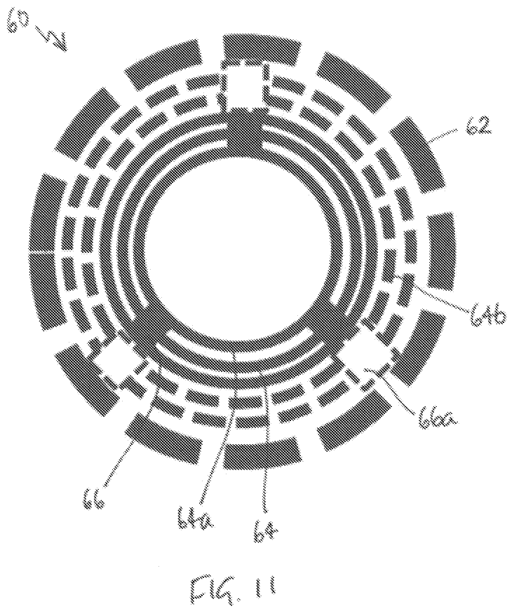

FIG. 10 shows a transverse cross-sectional view through a first example preform suitable for making a hollow core antiresonant optical fibre as disclosed herein. The preform 60 comprises a plurality of concentric glass tubes. An outermost tube 62 has a relatively large, first, wall thickness, which will form the jacket of the finished fibre. Arranged within the hollow lumen inside the outermost tube 62 are a plurality of tubes 64 of thinner wall thickness and of decreasing diameter, inserted one inside the other in order of decreasing size. These will form the flat planar glass membranes of the finished fibre. These tubes 64 may all have the same wall thickness, or it may be necessary to use tubes 64 with different wall thicknesses in order to provide different membrane thicknesses in the finished fibre, or to form membranes having the same thickness, depending on the dynamics of the later fibre draw. The decreasing sizes are selected such that the thinner tubes 64 are spaced apart from one another and from the outermost tube by appropriate amounts so as to create the gaps between the membranes in the finished fibre, including any larger gap to create sink cavities or to create different spacings between membranes in a group, and also to avoid any contact points between the individual membranes. The space inside the smallest, innermost tube 64a will form the hollow core in the finished fibre. Hence, the innermost tube 64a will form the core boundary glass membranes, and the tubes 64b intermediate between the innermost tube 64a and the outermost tube 62 will form the cladding glass membranes. In this example there is a total of five thinner glass tubes 64 so that the groups of membranes in the finished fibre will each comprise five spaced apart flat planar glass membranes; more or fewer thinner glass tubes can be included as required.

In order to anchor the membranes to the jacket in the finished fibre, the preform 60 also comprises a plurality of bulk glass spacer elements 66, in this example in the form of solid rods. These are interposed between all the tubes 62, 64 and extend across the spaces between the adjacent tubes and grouped to correspond with each corner or vertex of the intended polygonal shape of the hollow core in the finished fibre. In this example, the intended shape is an equilateral triangle, so there are three groups of spacer elements 66, the groups evenly distributed around the circumference of the preform 60, located one at each core corner position. Each group comprises at least one spacer element 66 in each space between adjacent tubes 62, 64 at the core position. In this example, six solid rods are placed in each space, the rods in contact with one another. When the preform is heated and drawn, the spacer elements fuse together with each other and with the portions of the tubes that lie between the spacer elements of the group, to create the protruding portions of the glass jacket in the finished fibre. Also during drawing, when the same pressure is applied to all voids between the various glass parts in the preform, the portions of the thinner glass tubes between the spacer elements will be flattened by surface tension so as to extend in straight lines between adjacent protruding portions and so create the glass membranes.

In another alternative, a preform may be assembled in stages, from the inner tubes outwards.

FIG. 11 shows a transverse cross-sectional view through a second example preform suitable for making a hollow core antiresonant optical fibre as disclosed herein, which is assembled in stages. In an initial stage, a number, in this example three as shown in solid lines, of the smaller of the thinner tubes 64a, 64 are arranged in the required concentric manner as described above, spaced apart by a group of spacer elements 66 at each corner core position. In a next stage, this partial assembly is consolidated by a minor draw to reduce the diameter somewhat (or to an intermediate diameter suitable for a cane) and fuse the various parts together. In a next stage, more and larger thinner tubes 64 are arranged around the consolidated partial assembly, again concentrically, with further spacer elements 66a. These are shown in dotted lines. If these additional tubes will complete the preform 60, the outermost tube 62 is the thicker tube to form the fibre jacket, otherwise only thinner tubes 64b are added. In the former case, the preform is complete, in the latter case, a further consolidation is performed followed by the addition of further tubes and spacer elements out to the thicker tube, as required. This process may provide a more stable way to build by the multiple glass layers required in the preform.

Preforms may also be formed from different stack designs, such as the inclusion of hollow tubes or other hollow elements which are collapsed during drawing to form the protruding elements. Alternatively, hollow elements for the protruding elements may be maintained hollow into the finished fibre by the application of suitable pressure during the draw process; this reduces the amount of material required to make the fibre, and reduces the weight of the finished fibre Other techniques may also be used to fabricate suitable preforms, such as shaping from a solid glass slab by drilling or laser cutting. These processes are simplified since the ease of drawing under a single pressure removes requirements for a preform to be particularly long and thin; shorter and broader preform dimensions can be used, which are easier to shape via drilling and cutting.

Example dimensions for fibres as proposed herein include:
Membrane thicknesses (“t” in FIG. 4) in the range of about 350 nm to 600 nm, which give optical guidance of light with a wavelength of 1550 nm, which is commonly used in telecommunications applications.
Jacket outer diameter in the range of 125 μm to 400 μm, where 125 μm is the industry standard for conventional solid fibre so providing ease of integration of hollow core and solid fibre types, while larger diameters are useful in other situations. An outer diameter in the range of 200 μm to 250 μm is common for known hollow core fibres, also allowing ease of integration and operation with existing hollow core fibre apparatus and devices when implemented for the currently described fibres.
Jacket internal diameter (diameter of the central lumen) in the range of 80 μm to 200 μm. The modelled fibres shown in FIG. 9 have a jacket internal diameter of 150 μm, for example.
Membrane spacing (“s” in FIG. 4) in the range of 1 μm to 5 μm. The modelled fibres shown in FIG. 9 have a membrane spacing of 3 μm for the lowest loss design of sixteen membranes, for example.
Sink cavity size (“z” in FIG. 6, being the cavity depth along the radial direction of the fibre) of approximately 0.9 times the core radius (“R” in FIG. 8) is useful for sinking the first higher order mode [3], although smaller and larger values of z may be used to tailor the higher mode attenuation.
Core radius (“R” in FIG. 8 in the range of: 20 u to 50 μm is appropriate for guiding of 1550 nm light, commonly used in telecommunications as noted above.

These values are merely examples, however, and are not limiting. Optical fibres according to the present disclosure may be implemented with other values, where the values can be selected to tailor the optical properties and characteristics of the optical fibre for particular applications, as required.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in the future.

### REFERENCES

[1] Chen, Yong, et al. “Multi-kilometer long, longitudinally uniform hollow core photonic bandgap fibers for broadband low latency data transmission.” Journal of Lightwave Technology 34.1, 104-113, 2016
[2] U.S. Pat. No. 11,203,547
[3] Francesco Poletti, “Nested antiresonant nodeless hollow core fiber,” Opt. Express, vol. 22, 23807-23828, 2014
[4] Cruz, A.L.S. et al “3D-printed terahertz Bragg fiber”, In Proceedings of the 2015 40th International Conference on Infrared, Millimeter, and Terahertz waves (IRMMW-THz), Hong Kong, China, 23-28 August 2015; pp. 1-2.
[5] Li, J. et al, “3D printed hollow core terahertz Bragg waveguides with defect layers for surface sensing applications”, Opt. Express 2017, 25, 4126-4144.
[6] Hong, B. et al, “Low-Loss Asymptotically Single-Mode THz Bragg Fiber Fabricated by Digital Light Processing Rapid Prototyping” IEEE Trans. Terahertz Sci. Technol. 2018, 8, 90-99.
[7] Hayes, John R. et al., “Anti-resonant hexagram hollow core fibers.” Optics Express 23.2 (2015): 1289-1299.
[8] CN 108181685
[9] CN 110579836
[10] CN 109031517
[11] CN 101836143 (WO 2009044100)

1. A hollow core optical fibre configured for guidance of an optical wave by antiresonance, comprising:
a tubular glass jacket with a central lumen and a wall with a wall thickness;
a hollow core defined in the central lumen and having in transverse cross-section a polygonal shape; and
a cladding located in the central lumen and comprising flat planar glass membranes each having two opposite edges extending along a length of the hollow core optical fibre and a membrane thickness less than the wall thickness, the glass membranes arranged as a plurality of groups of glass membranes, each group comprising:
a core boundary glass membrane defining one side of the polygonal shape of the hollow core; and
at least one cladding glass membrane located between the core boundary glass membrane and the tubular glass jacket, all glass membranes in the group being spaced apart from one another;
wherein every side of the polygonal shape of the hollow core is formed by a core boundary glass membrane, every glass membrane is anchored to the tubular glass jacket only along its two opposite edges, and there is no contact between any of the glass membranes.

2. A hollow core optical fibre according to claim 1, wherein the polygonal shape of the hollow core is a regular polygon.

3. A hollow core optical fibre according to claim1 wherein the polygonal shape is a triangle, such that the plurality of groups of glass membranes consists of three groups of glass membranes.

4. A hollow core optical fibre according to claim 1, wherein each group of glass membranes comprises more than two glass membranes.

5. A hollow core optical fibre according to claim 1, wherein each group of glass membranes consists of an equal number of glass membranes as the other groups of glass membranes.

6. A hollow core optical fibre according to claim 1, wherein the glass membranes in each group of glass membranes are parallel to one another.

7. A hollow core optical fibre according to claim 1, wherein the glass membranes in each group of glass membranes are spaced apart from one another by spaces of equal depth and optionally wherein the each group of glass membranes has spaces equal in depth to the spaces in the other groups of glass membranes.

8. A hollow core optical fibre claim 1, further comprising a cavity between each group of glass membranes and the tubular glass jacket, each cavity having a depth greater than the depth of the paces by which the glass membranes in the group are spaced apart.

9. A hollow core optical fibre according to claim 8, further comprising secondary glass membranes arranged between each cavity and the tubular glass jacket, every secondary glass membrane anchored to the tubular glass jacket only along its two opposite edges and optionally wherein each cavity has at least two secondary glass membranes associated with it, the at least two secondary glass membranes spaced apart from one another.

10. A hollow core optical fibre according to claim 9, wherein the secondary glass membranes associated with each cavity comprise at least two groups of secondary glass membranes, each group of secondary glass membranes arranged such that the associated cavity has a transverse cross-sectional shape with sides defined by an outermost cladding glass membrane in the group of glass membranes and an innermost secondary glass membrane in each group of secondary glass membranes, and optionally wherein the secondary glass membranes associated with each cavity consist of two groups of secondary glass membranes and the associated cavity has a triangular transverse cross-sectional shape.

11. A hollow core optical fibre according to claim 1, wherein the wall of the tubular glass jacket has a plurality of bulk glass protruding portions protruding into the central lumen, each protruding portion aligned with a vertex of the polygonal shape of the hollow core, and each glass membrane being anchored to the tubular glass jacket by its two opposite edges being respectively anchored to adjacent protruding portions.

12. A hollow core optical fibre according to claim 1, wherein the lumen of the tubular glass jacket has a circular transverse cross-sectional shape.

13. A preform for fabricating a hollow core optical fibre configured for guidance of an optical wave by antiresonance according to claim 1, the preform comprising:
a plurality of hollow glass tubes with walls each having a thickness, and of decreasing diameter arranged concentrically one inside another with spaces between the hollow glass tubes, to provide the flat planar glass membranes of the hollow core optical fibre;
an outer hollow glass tube arranged concentrically around, and spaced apart from, the plurality of hollow glass tubes, and having a wall of a thickness greater than the thickness of each of the walls of the hollow glass tubes, to provide the tubular glass jacket of the hollow core fibre; and
three or more groups of glass spacer elements, the groups spaced circumferentially apart around the preform in correspondence with corners of the polygonal shape of the hollow core of the hollow core fibre, the spacer elements in each group comprising at least one spacer element

14. A method of making a preform for fabricating a hollow core optical fibre configured for guidance of an optical wave by antiresonance, the preform according to claim 13, the method comprising:
a first stage comprising making a partial assembly by arranging a plurality of hollow glass tubes with walls each having a thickness and of decreasing diameter concentrically inside one another with spaces between the hollow glass tubes and arranging glass spacer elements in the spaces between the hollow glass tubes, the spacer elements arranged in at least three groups which are spaced circumferentially about the hollow glass tubes, the spacer elements in each group comprising at least one spacer element in each space between the hollow glass tubes;
a second stage comprising drawing the partial assembly down to reduce its diameter and consolidate the hollow glass tubes with the spacer elements;
a third stage comprising optionally arranging further hollow glass tubes and further glass spacer elements around the partial assembly if more hollow glass tubes are required in the preform, the further glass spacer elements aligned with the groups in the partial assembly; and
a fourth stage comprising arranging any further hollow glass tubes required in the preform concentrically around the partial assembly, and arranging an outer hollow glass tube with a wall of a thickness greater than the thickness of each of the walls of the hollow glass tubes concentrically around an outermost of the hollow glass tubes with a space between, and arranging still further glass spacer elements in each space between the hollow glass tubes and the outer hollow glass tubes, the still further glass spacer elements aligned with the groups in the partial assembly.

15. A method of fabricating a hollow core optical fibre configured for guidance of an optical wave by antiresonance, the method comprising:
heating and drawing a preform according to claim 13 to form an optical fibre and optionally wherein equal pressures are applied to all voids in the preform during the drawing
